(19) United States
(12) Patent Application Publication
(10) Pub. No.: US 2019/0356719 A1
(43) Pub. Date: Nov. 21, 2019

(54) SHARING A WEB PAGE AND A CORRESPONDING RECORD

(71) Applicant: International Business Machines Corporation, Armonk, NY (US)

(72) Inventors: Victor Povar, Vancouver (CA); Sarbajit K. Rakshit, Kolkata (IN); Craig M. Trim, Sylmar, CA (US)

(21) Appl. No.: 15/980,531

(22) Filed: May 15, 2018

(51) Int. Cl. H04L 29/08; G06F 17/30; G06F 21/62

(52) U.S. Cl. CPC H04L 67/02; G06F 17/30873; G06F 21/6218; H04L 67/12; G06F 17/30887; H04L 67/10; G06F 17/3089

(57) ABSTRACT

A method includes receiving, by a computing device, a sequence of inputs regarding navigation from a first web page to a final web page and data entry. The method further includes capturing, by the computing device, the sequence of inputs, web addresses for web pages from the first to the final web page, user information associated, graphical data of the web pages, and graphical data regarding the data entry to produce captured web page data. The method further includes identifying, by the computing device, confidential information associated with the captured web page data. The method further includes generating, by the computing device, a record based on the captured web page data, wherein the record is generated in a manner that protects the confidential information from unauthorized access. The method further includes sending, by the computing device, the record to another computing device.

### TECHNICAL FIELD OF THE INVENTION

This invention relates generally to computing network systems and more particularly to computing device operations.

### BACKGROUND OF THE INVENTION

A computer network system typically includes a plurality of computers, one or more servers, one or more local area networks (LAN), and/or one or more wide area networks (WAN). A computer includes a central processing unit (CPU), a memory system, user input/output interfaces, peripheral device interfaces, and an interconnecting bus structure. In general, a server is a computer that provides functionality for other computers in the system. Within the system, a server serves multiple computers and a computer can use multiple servers.

Within the system, computers communicate data, process data, and/or store data. Such computers range from wireless smart phones, laptops, tablets, personal computers (PC), work stations, and video game devices, to data centers that support millions of web searches, stock trades, or on-line purchases every day.

As is known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

Within the computer network system, one computer can share data with another computer. The data may be an email, an image file, a data file, a video file, a link to a web site, etc. The data may be shared directly with the other computer or indirectly via the LAN, the WAN, and/or with support of one or more servers. Direct sharing of data can be done via a radio frequency (RF) connection a flash drive, or a cable.

### BRIEF DESCRIPTION OF THE SEVERAL VIEWS OF THE DRAWING(S)

FIG. 1 depicts a cloud computing environment according to an embodiment of the present invention;

FIG. 2 depicts abstraction model layers according to an embodiment of the present invention;

FIG. 3 is a schematic block diagram of an embodiment of a computing network system in accordance with the present invention;

FIG. 4 is a schematic block diagram of an embodiment of a computing device in accordance with the present invention;

FIG. 5 is a schematic block diagram of another embodiment of a computing device in accordance with the present invention;

FIG. 6 is a schematic block diagram of an embodiment of a storage unit in accordance with the present invention;

FIG. 7 is a schematic block diagram of an embodiment of a cloud storage unit in accordance with the present invention;

FIG. 8 is a block diagram of an example of navigating a first web page in accordance with the present invention;

FIG. 9 is a block diagram of an example of navigating a second web page in accordance with the present invention;

FIG. 10 is a block diagram of an example of navigating a third web page in accordance with the present invention;

FIG. 11 is a block diagram of an example of navigating a fourth web page in accordance with the present invention;

FIG. 12 is a block diagram of an example of navigating a fifth web page in accordance with the present invention;

FIG. 13 is a block diagram of an example of navigating a final web page in accordance with the present invention;

FIG. 14 is a schematic block diagram of an example of a record created for the example of FIGS. 8-13 in accordance with the present invention;

FIG. 15 is a logic diagram of an example of a method for creating a record for web pages in accordance with the present invention;

FIG. 16 is a logic diagram of an example of a method for creating a record for web pages in accordance with the present invention; and

FIG. 17 is a logic diagram of an example of a method for creating a record for web pages in accordance with the present invention.

### DETAILED DESCRIPTION OF THE INVENTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

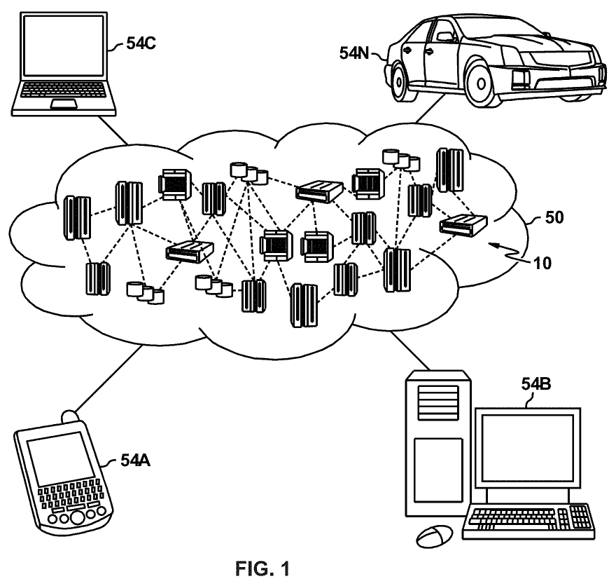

FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

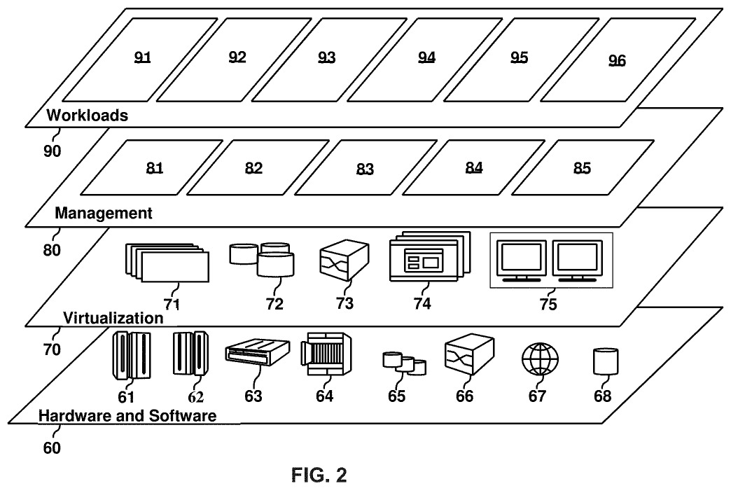

FIG. 2 is a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data sharing.

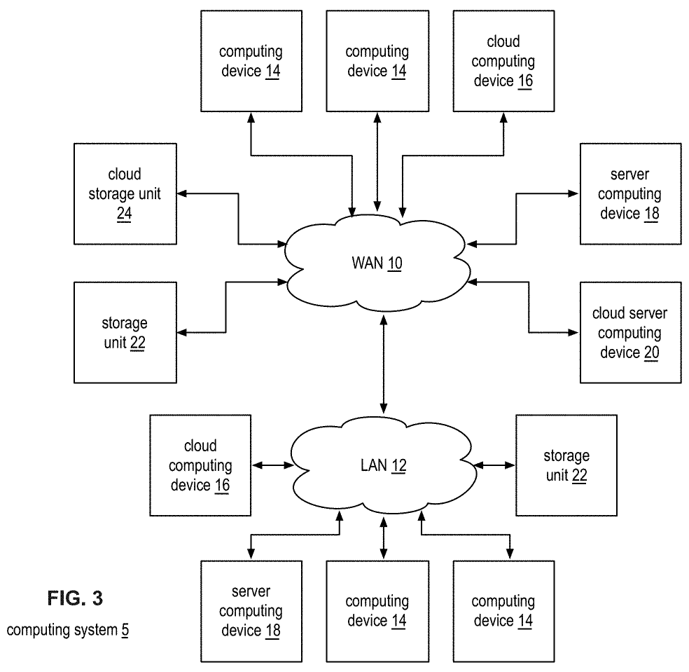

FIG. 3 is a schematic block diagram of an embodiment of a computing network system 5 that includes one or more wide area networks (WAN) 10, one more local area networks (LAN) 12, a plurality of computing devices 14, a plurality of cloud computing devices 16, a plurality of server computing devices 18, a plurality of cloud server computing devices 20, a plurality of storage units 22, and a one or more cloud storage units 24. Note that other computing network systems may include more or less components than shown in FIG. 1. For example, another computing network system includes LAN 12, a server computing device 18, and a plurality of computing devices 14.

Each type of the computing devices 14-20 includes a computing core and one or more network interfaces to connect to the WAN 10 and/or the LAN 12 as will be described in greater detail with reference to FIGS. 2 and 3. Each computing device may be a portable computing device and/or a fixed computing device. A portable computing device includes, but is not limited to, a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device includes, but is not limited to, a personal computer (PC), a computer server, a cable set-top box, a satellite receiver, a television set, a printer, a fax machine, home entertainment equipment, a video game console, and/or any type of home or office computing equipment.

Each of the server computing devices 18 and 20 provides one or more server functions that includes, but is not limited to, a web server, an application server, a proxy server, a mail server, a virtual server, a file server, or a policy server. In general:

a) A web server is a program executed on a server computing device to service requests for HTML (Hypertext Markup Language) pages or file for clients (e.g., computing devices 14 and 16). As an example, a web browser program running on a computing device (i.e., the client) requests an HTML file from the web server.

b) An application server is a program executed on a server computing device to provide web applications and/or desktop applications. An application server typically includes programming languages, runtime libraries, databases or connections thereto, and administrative functionality related thereto.

c) A proxy server is a program executed on a server computing device to function as an intermediary between endpoint devices (e.g., a computing device and a server computing device, etc.).

d) A mail server is a program executed on a server computing device that receives incoming email from local users (e.g., computing devices within the same domain) and remote senders and forwards outgoing email for delivery.

e) A virtual server is a program executed on a shared server computing device that is configures such that each user computing device seems like it has control over the server.

f) A file server is a program executed on a server computing device that is responsible for the central storage and management of data files so that the computing devices have access to data files.

g) A policy server is a program executed on a server computing device that provides security for the computing network system including, but not limited to, authorization services, tracking, and file control.

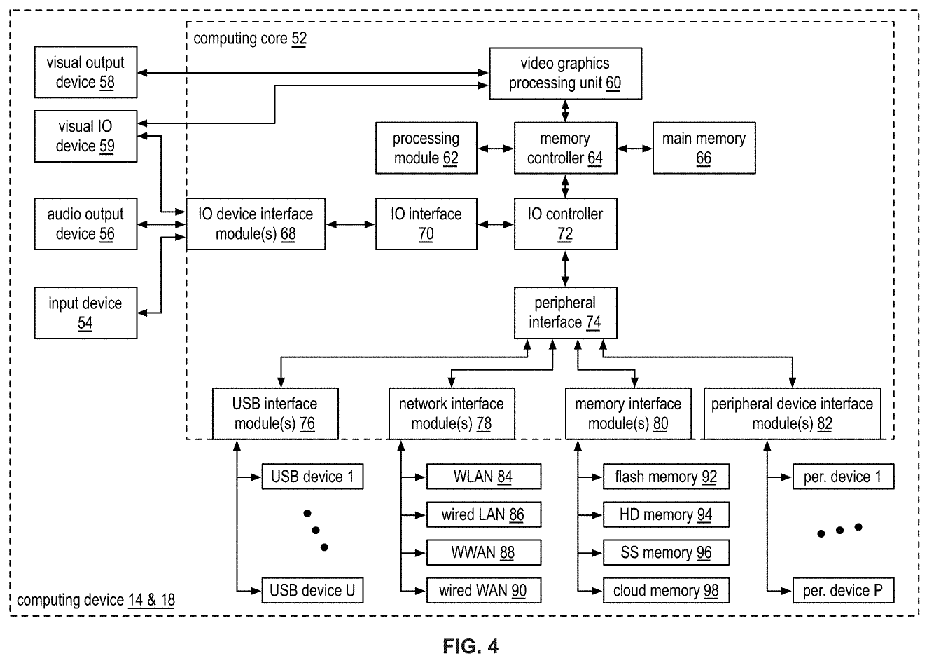

Each of the storage units 22 includes file server functionality to store data files, data objects, etc. that are accessible to one or more of the computing devices 14 and 16 and/or to one or more of the server computing devices 18 and 20. An embodiment of a storage unit 22 is discussed with reference to FIG. 4.

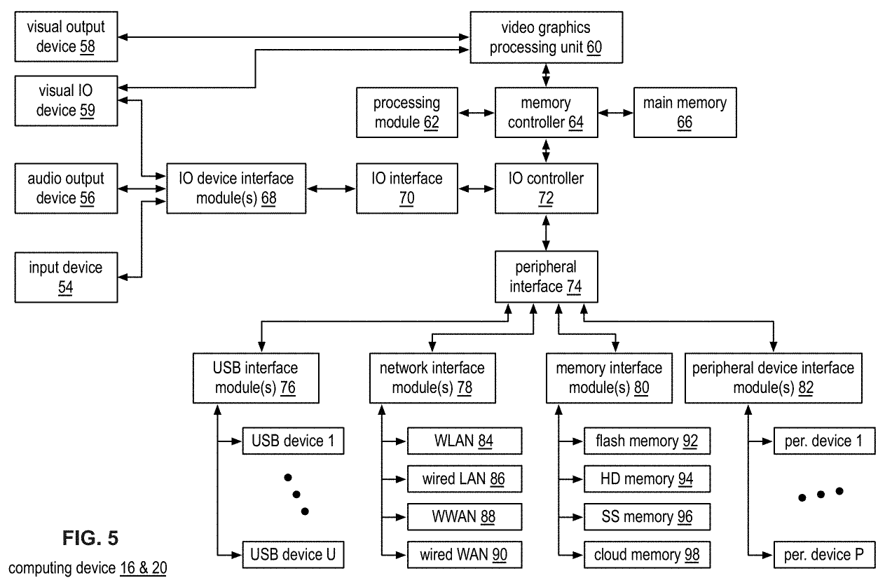

The cloud storage unit 24 provides error encoding and dispersed storage for data files, data objects, etc. for one or more of the computing devices 14 and 16 and/or to one or more of the server computing devices 18 and 20. An embodiment of the cloud storage unit 24 is discussed with reference to FIG. 5.

Within the computing network system 5, the computing devices 14 and 16 and/or the server computing devices 18 and 20 perform specific tasks to achieve desired objectives. The computing devices 14 and 16 and/or the server computing devices 18 and 20 may work individually, collectively, or a combination thereof to achieve a specific desired objective. For example, to store a file created by a computing device 14, the computing device 14 utilizes an application from an application server to create the file. It then utilizes a file server to store the file. To reach the file server, the computing device may utilize one or more proxy servers. Other innovative examples are provided herein.

FIG. 4 is a schematic block diagram of an embodiment of a computing device 14 and server computing device 18 that includes a computing core 52, one or more input devices 54 (e.g., keypad, keyboard, voice to text, etc.), one or more audio output devices 56 (e.g., speaker(s), headphone jack, etc.), one or more visual output devices 58 (e.g., video graphics display, etc.), a visual IO device 59 (e.g., a touchscreen), one or more universal serial bus (USB) devices, one or more networking devices (e.g., a wireless local area network (WLAN) device 84, a wired LAN device 86, a wireless wide area network (WWAN) device 88 (e.g., a cellular telephone transceiver, a wireless data network transceiver, etc.), and/or a wired WAN device 90), one or more memory devices (e.g., a flash memory device 92, one or more hard drives 94, one or more solid state (SS) memory devices 96, and/or cloud memory processing module 98), and one or more peripheral devices.

The cloud memory processing module 98 provides the interface for connecting to the cloud storage unit 24. As will be discussed in greater detail with reference to FIG. 5, data stored in the cloud storage unit 24 is error encoded and then distributedly stored among a set of storage units. The cloud memory processing module 98 may function in a variety of ways to interface with the cloud storage unit 24. In one example, it provides the data to be stored to the cloud memory unit 24, which does the error encoding and distributed storage. In another example, the cloud memory processing module 98 performs the error encoding and provided encoded data slices to the cloud memory unit 24, which performs the distributed storage.

The computing core 52 includes a video graphics processing unit 60, one or more processing modules 62, a memory controller 64, main memory 66 (e.g., RAM), one or more input/output (I/O) device interface module 68, an input/output (I/O) interface 70, an input/output (I/O) controller 72, a peripheral interface 74, one or more USB interface modules 76, one or more network interface modules 78, one or more memory interface modules 80, and/or one or more peripheral device interface modules 82.

Each of the interface modules 68, 76, 78, 80, and 82 includes a combination of hardware (e.g., connectors, wiring, etc.) and operational instructions stored on memory (e.g., driver software) that is executed by the processing module 62 and/or a processing circuit within the interface module. Each of the interface modules couples to one or more components of the computing device 14 or 18. For example, one of the IO device interface modules 68 couples to an audio output device 56. As another example, one of the memory interface modules 80 couples to flash memory 92 and another one of the memory interface modules 80 couples to cloud memory 98 (e.g., an on-line storage system and/or on-line backup system).

The components of the computing device of FIG. 2 are typically housed in a single package to form a portable or fixed computing device. For example, a computing device 14 is a cell phone and is housed in a cell phone package. As another example, a server computing device 14 is a personal computer and is housed in a personal computer chassis.

FIG. 5 is a schematic block diagram of another embodiment of a computing device 16 and 20. This diagram is similar to FIG. 2 in that it includes a video graphics processing unit 60, one or more processing modules 62, a memory controller 64, main memory 66, one or more input/output (I/O) device interface module 68, an input/output (I/O) interface 70, an input/output (I/O) controller 72, a peripheral interface 74, one or more USB interface modules 76, one or more network interface modules 78, one or more memory interface modules 80, and/or one or more peripheral device interface modules 82.

It also includes one or more input devices 54, one or more audio output devices 56, one or more visual output devices 58, a visual IO device 59, one or more universal serial bus (USB) devices, a wireless local area network (WLAN) device 84, a wired LAN device 86, a wireless wide area network (WWAN) device 88, a wired WAN device 90), a flash memory device 92, one or more hard drives 94, one or more solid state (SS) memory devices 96, cloud memory processing module 98, and one or more peripheral devices.

This embodiment differs from the embodiment of FIG. 2, in that, this embodiment is not typically housed in a single package. For example, the components are distributed throughout the network and function distributedly. As another example, the user IO devices 54, 56, 58, and 59 are in a package that enables the user to interact with the other components that housed in one or more other packages coupled to the network. In another example, computing device 14 of FIG. 2 utilizes one or more components of computing device 16 to extend the operations of computing device 14.

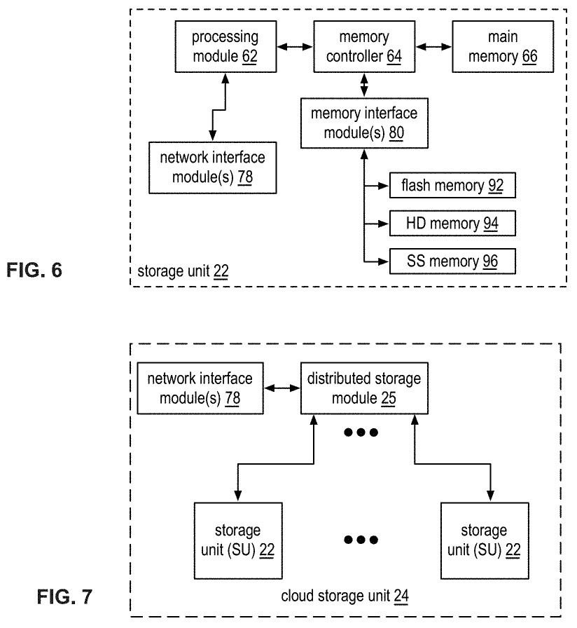

FIG. 6 is a schematic block diagram of an embodiment of a storage unit 22 that includes one or more processing modules 62, one or more memory controllers 64, one or more main memories 66, one or more network interface modules 78, one or more memory interface modules 80, and a plurality of memory devices. The memory device includes one or more of: a plurality of flash memory 92, a plurality of hard drive memory 94, and a plurality of solid-state (SS) memory 96.

In an example of operation, the processing module 62 executes a file server function to facilitate the storage and retrieval of data to and from the memory devices. The storage unit 22 communicates with the computing devices 14-20 of the computing network system 5 via the network interface module(s) 78.

FIG. 7 is a schematic block diagram of an embodiment of a cloud storage unit 24 that includes a distributed storage module 25, a set of storage units 22, and one or more network interface modules 78. The distributed storage module 25 may be a processing module in a stand-alone computing device or a processing module in one or more of the computing devices 14-20 of the computing network system 5.

The distributed storage module 25 functions to error encoded the data to produce sets of encoded data slices and to distributedly stored on the sets of encoded data slices in the set of storage units 22. In an example, the distributed storage module 25 receives a data object for storage. It segments the data object into data segments in accordance with a data segmenting protocol e.g., data segment size, fixed, variable, etc.). For a data segment, the distributed storage module 25 error encodes it using an encoding function (e.g., information dispersal algorithm, Reed-Solomon, Cauchy Reed-Solomon, systematic encoding, non-systematic encoding, on-line codes, etc.) to produce a set of encoded data slices. It then sends the set of encoded data slices to the set of storage units for storage therein.

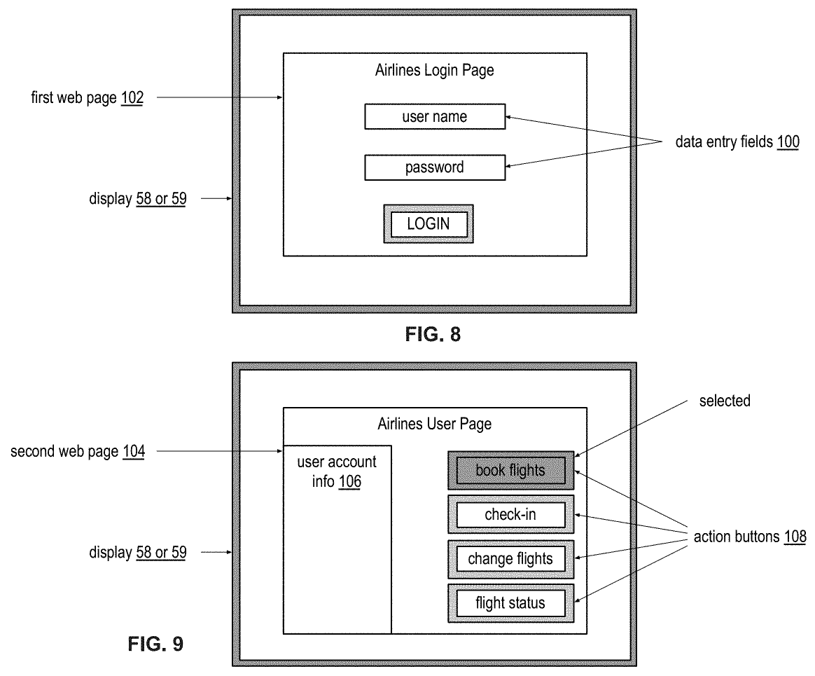

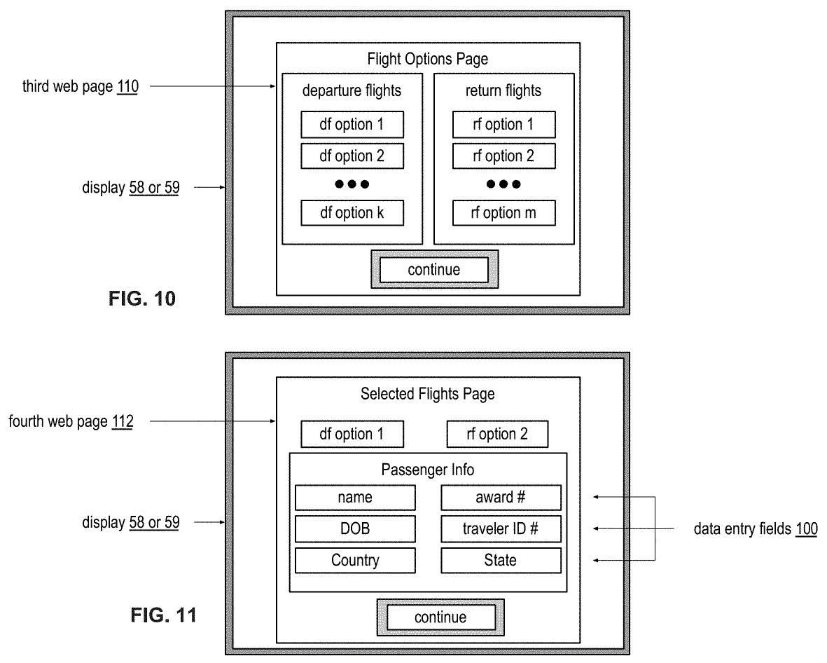

FIGS. 8 through 11 are block diagrams of an example of navigating web pages from a first web page 102 to a final web page 116 regarding the purchase of an airline ticket. Note that the concepts discussed with reference to this example are applicable to a wide variety of sequences of computer operations. For example, the concepts are applicable to any type of web page navigation. As another example, the concepts are applicable to searches using a search engine. As yet another example, the concepts are application for database navigation and/or searches.

In FIG. 8, a user of a computing device navigates to an airlines login page. A graphical image of the airlines login page, which is the first web page 102 in this example, is displayed on the computing device's display 58 or 59. The user may arrive at the airlines login page through a stored web-page address (e.g., URL—Uniform Resource Locator) of the login page, through a search function, by entering the URL, etc.

Among other images, graphics, buttons, data entry fields, etc., the login page includes data entry fields 100 for a user name and a password. The user, via the computing device, enters his or her user name in the user name field and his or her password in the password field. The computing device displays the entry of the data into the data fields in a conventional manner. The computing device also records, logs, captures, or otherwise stores information regarding the first web page (e.g., the login page) and the inputs entered into the login page (e.g., the user name and the password). For example, the computing device takes a screenshot of the login page and caches the user name and password. As another example, the computing device stores a graphical representation of the login page so that the computing device can recreate the login page at a later time.

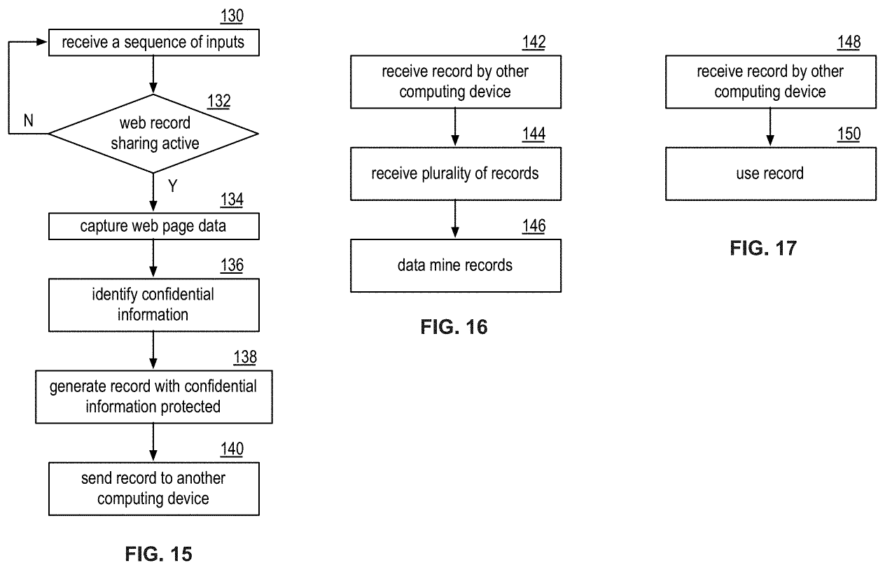

As the computing device is recording the inputs, the computing device is monitoring the inputs to determine if one or more of the inputs are confidential information. For the purposes of this application, confidential information shall mean information that most people would not want to share with the general public. In this example, the computing device determines that the password is confidential information and records the password as well. Note that there are a variety of ways in which the computing device can detect confidential information, which will be discussed in greater detail with reference to FIG. 15.

Once the inputs have been entered, the user, via the computing device, selects the login button. Assuming the user has an account with the airlines and has entered the user name and password correctly, the corresponding web server sends the second web page 104 to the computing device of the user.

FIG. 9 illustrates an example of the second web page 104 being displayed on the computing device's display 58 or 59. The second web page 104 is shown as the airlines user page that includes, among other things, the user's account information 106 and action buttons 108. The user account information 106 includes the user's name, the user's account number, the user's frequently flyer status, the user's mileage program status, etc. The action buttons include book flights, check-in, change flights, and flight status.

In this example, the book flights button is selected. The computing device records the second web page 104 and the corresponding actions. In addition, the computing device reviews the user account information to identify confidential information. For example, the computing device identifies the user's account number, the user's frequently flyer status, and the user's mileage program status as confidential information and records the confidential information.

Having selected the book flights button, the web server returns a flight options page as shown in FIG. 8, which corresponds to the third web page 110. The flight options page includes departing flight (df) options, return flight (rf) options, and continue. Not shown are date options, departure options, and destination options. For the purposes of this example, it is assumed that dates, departure airport and destination airport have been properly selected.

The user, via the computing device selects a departure flight and a return flight, then selects continue. The computing device records the flight option page and the inputs entered by the user to select the departure flight and return flight. The computing device also scans the inputs and data on the web page to identify confidential information. For this page, there is no confidential information. After selecting the continue button, the web server provides the computing device with a selected flights page.

FIG. 11 illustrates the selected flights page, which corresponds to the fourth web page 112. This page includes, among other things, the selected departure flight (df option 1), the selected return flight (rf option 2), and the passenger information. The passenger information includes data entry fields 100, which includes name, date of birth (DOB), country, award number, traveler ID number, and State. The computing devices records the selected flights page.

As the user enters the passenger information, the computing device records it. In addition, the computing device determines which of the passenger information is confidential. In this example, the computing device determines that date of birth (DOB), award number, and traveler ID number are confidential. After entering the passenger information, the user selects, via the computing device, the continue button. In response, the web server sends the computing device a flight payment page.

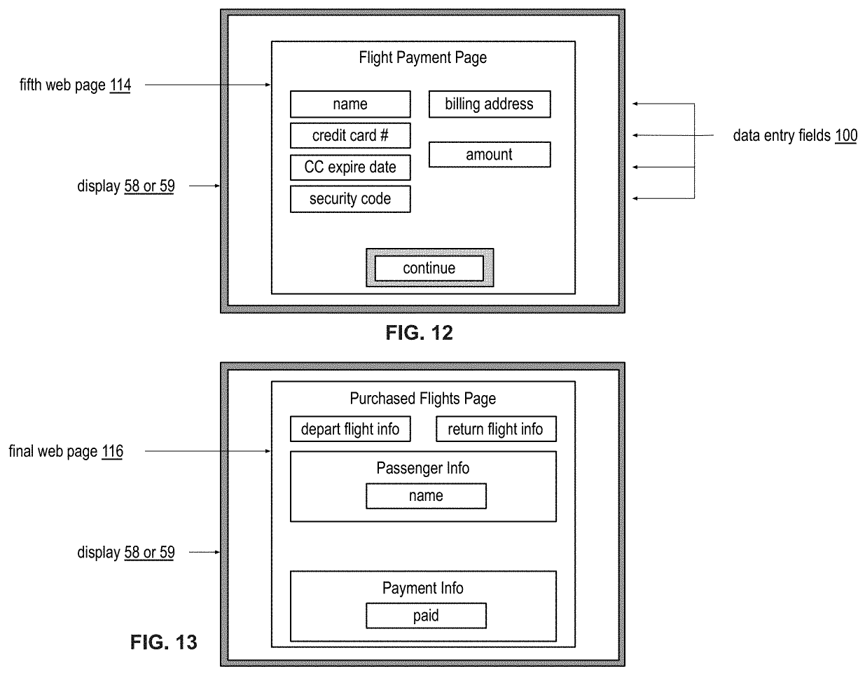

FIG. 12 illustrates the flight payment page, which corresponds to the fifth web page 114. This page includes, among other things, payment information, the amount owed, and a continue button. The payment information is shown to include name, credit card number, credit card (CC) expiration date, security code, and billing address. As the user enters the payment information via the computing device, the computing device records the web page and the inputs thereto.

The computing device interprets the payment information to determine which pieces are confidential information. In this example, the computing device deems the credit card number, credit card (CC) expiration date, security code, and billing address as confidential. After the payment information is entered, the user selects, via the computing device, the continue button. When the purchase is accepted, the web server provides a purchased flight page to the computing device.

FIG. 13 illustrates the purchased flights page, which corresponds to the sixth and final web page 116 of this example. The purchased flight page includes the departing flight information, the return flight information, the passenger's name, and an indication that the flights have been successfully purchased. The computing device records this page.

With the six web pages recorded, the corresponding inputs recorded, and the confidential information identified and recorded, the computing device creates a record of the web page navigation to share with another computing device. For example, the user of the computing device may desire to share his or her flight information with a colleague (e.g., user of the other computing device) such that they can travel together to an upcoming event. By sharing the record of the web page navigation and corresponding data inputs, the user of the other computing device can readily traverse the same web pages to easily book a seat on the same flight.

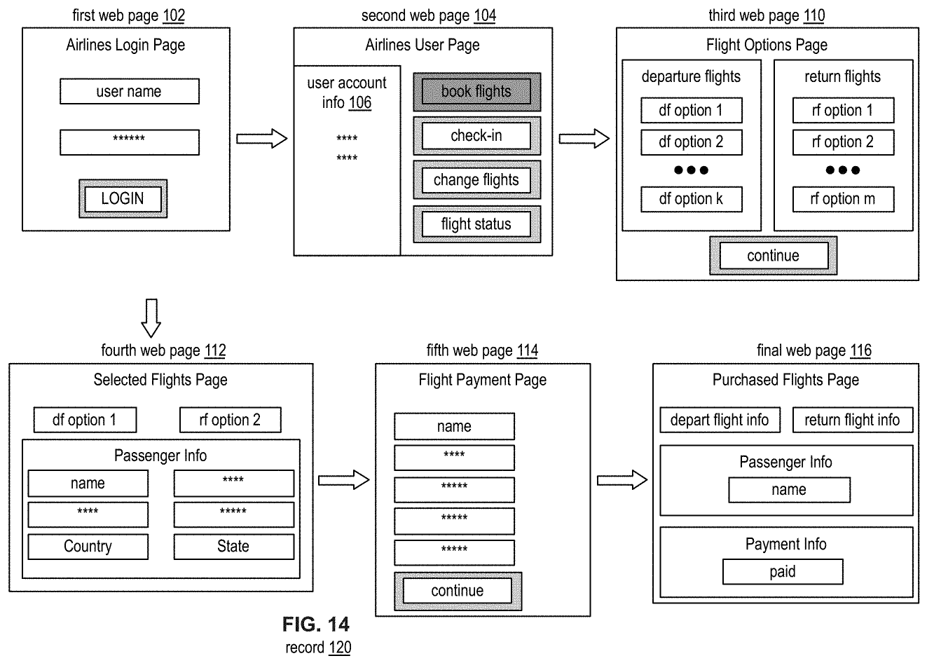

FIG. 14 is a schematic block diagram of an example of a record created for the example of FIGS. 8-13. In this example, the record is a pictorial representation of the web pages navigated by the user of the computing device to purchase airline tickets. In another example, the record could include a list of web pages (e.g., URLs) and list of inputs for each web page, less the confidential information.

The record begins with the recording of first web page 102, which is for the airlines login page. The record includes the URL for the airlines login page and a representation of the page with the user's data entered and the confidential information protected. As discussed above, the computing device determined that the user's password is confidential information and is masked, deleted from the record, or otherwise protected. In this example, it is masked using asterisks.

The record continues graphically via an arrow (or other means of flow indication) to the recording of the second web page 104, which is for the airlines user page. The record includes the URL for the airlines user page and a representation of the page with the user's data entered and the confidential information protected. As discussed above, the computing device determined that the user account information is confidential information and is masked, deleted from the record, or otherwise protected. In this example, it is masked using asterisks.

The record continues graphically via an arrow to the recording of the third web page 110, which is for the flight options page. The record includes the URL for the flight options page and a representation of the page with the user's data entered. As discussed above, the computing device determined that this page does not include any confidential information.

The record continues graphically via an arrow to the recording of the fourth web page 112, which is for the selected flights page. The record includes the URL for the selected flights page and a representation of the page with the user's data entered and the confidential information protected. As discussed above, the computing device determined that the passenger's date of birth, award number, and traveler ID number are confidential and are masked, deleted from the record, or otherwise protected. In this example, it is masked using asterisks.

The record continues graphically via an arrow to the recording of the fifth web page 114, which is for the flight payment page. The record includes the URL for the flight payment page and a representation of the page with the user's data entered and the confidential information protected. As discussed above, the computing device determined that the credit card number, the expiration date, the security code, and the billing address are confidential and are masked, deleted from the record, or otherwise protected. In this example, it is masked using asterisks.

The record continues graphically via an arrow to the recording of the sixth and final web page 116, which is for the purchased flights page. The record includes the URL for the purchased flights page and a representation of the data on the page; there is no user inputted data for this page nor is there confidential information. The record makes it easy for others to mimic the same steps to achieve similar results. Note that non-confidential information may be automatically entered.

FIG. 15 is a logic diagram of an example of a method for creating a record for web pages that begins at step 130 where a computing device receives a sequence of inputs regarding navigation from a first web page to a final web page and data entry into one or more web pages of the first web page to the final page. FIGS. 8 through 13 provides an example of the sequence of inputs. Note that the navigation from the first web page to the final web page may include multiple intervening web pages or no intervening web pages. The method continues to step 132 where the computing device determines whether the recording of the first web page to the final web page is activate. For example, the computing device activates the capturing, the identifying, the generating, and the sending of the recording of the first web page to the final web page automatically upon detecting access to the first web page. As another example, the computing device receives a command to activate the capturing, the identifying, the generating, and the sending of the recording of the first web page to the final web page.

When the recording is not activated, the method pauses until it is activated. When activated, the method continues at step 134 where the computing device captures one or more of: the sequence of inputs, web addresses for web pages from the first web page to the final web page, user information associated with the computing device, graphical data of the web pages from the first web page to the final web page, and graphical data regarding the data entry to produce captured web page data.

As an example, the computing device generating screenshots in correspondence with the sequence of inputs. There are a variety of ways to execute the screen shots and triggers for doing so. For instance, the computing device takes screenshots of each web page and may further take screenshots as the data is entered. As another example, the computing device accessing system memory of the computing device to obtain the user information. Note that the user information may be permanent or temporary depending on whether the system memory is associated with a private or public computing device.

As a still further example, the computing device records the Uniform Resource Locator (URL) of the web pages from the first web page to the final web page. As yet another example, the computing device records key strokes associated with the sequence of inputs and stores them in memory. As a yet further example, the computing device records the data entry as entered in memory. Further examples were discussed with reference to FIGS. 8-13.

The method continues at step 136 where the computing device identifies confidential information associated with the captured web page data. For example, the computing device identifies a data entry field on the one or more web pages as a confidential field (e.g., the password data entry field, the credit card number data entry field, etc.). As another example, the computing device interprets the data entry to determine a piece of confidential information (e.g., 16 digits is likely a credit card number, an unusual sequence of characters in a set of characters is likely a password, etc.).

The method continues at step 138 where the computing device generates a record based on the captured web page data and protects the confidential information from unauthorized access. For example, the computing device creates a step-by-step instruction set regarding at least some of the sequence of inputs. With reference to FIG. 12, the graphical representation of the traversing from the first web page to the final web page could be captured in text.

As another example, the computing device generates the record by creating a graphical flowchart that depicts at least some of the sequence of inputs. FIG. 12 is an example of a graphical flowchart. Note that, with respect to FIG. 12, not all of the web pages are needed to clearly inform a recipient of the record on how to traverse from page 1 to page 6. For instance, the flight payment page could be omitted with minimal loss of information regarding traversing from the first web page to the final web page.

To protect the confidential information in the record, the computing device can implement one of a variety of options. For example, the computing device masks the confidential information in the record. As another example, the computing device extracts the confidential information from the record. As yet another example, the computing device does not include the confidential information when generating the record.

The method continues to step 140 where the computing device sends the record to another computing device. The other computing device may use the record in a variety of ways.

For example, and with reference to FIG. 16, the other computing devices receives the record and a plurality of records from a plurality of computing devices in steps 142 and 144. The method of FIG. 16 continues at step 146 where the other computing device interprets the records to determine one or more of: access rate of various web pages, non-confidential information trends, non-confidential information patterns, and user preferences. The other computing device may also data mine for trends, frequency of visits, etc.

As another example of the other computing device using the record and with reference to FIG. 17, the other computing device receives the record at step 148. The method continues at step 150 where the computing device uses the record for a variety of purposes. For example, the other computing device uses the record to mimic one or more inputs of the sequence of inputs. As another example, the other computing device uses the record to access a particular web page of the first web page to the final web page. As yet another example, the other computing device uses the record to perform similar data entry to obtain a similar result as obtained by the computing device (e.g., purchase tickets on the same flight).

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for sharing a web page, the method comprises:
receiving, by a computing device, a sequence of inputs regarding navigation from a first web page to a final web page and data entry into one or more web pages of the first web page to the final page;
when activated:
capturing, by the computing device, one or more of: the sequence of inputs, web addresses for web pages from the first web page to the final web page, user information associated with the computing device, graphical data of the web pages from the first web page to the final web page, and graphical data regarding the data entry to produce captured web page data;
identifying, by the computing device, confidential information associated with the captured web page data;
generating, by the computing device, a record based on the captured web page data, wherein the record is generated in a manner that protects the confidential information from unauthorized access;
sending, by the computing device, the record to another computing device.

2. The method of claim 1 further comprises:
activating, by the computing device, the capturing, the identifying, the generating, and the sending automatically upon detection of accessing the first web page.

3. The method of claim 1 further comprises:
receiving, by the computing device, a command to activate the capturing, the identifying, the generating, and the sending.

4. The method of claim 1, wherein the capturing comprises one or more of:
generating screenshots in correspondence with the sequence of inputs;
accessing system memory of the computing device to obtain the user information;
recording Uniform Resource Locator (URL) of the web pages from the first web page to the final web page;
recording key strokes associated with the sequence of inputs; and
recording the data entry.

5. The method of claim 1, wherein the identifying the confidential information comprises one or more of:
identifying a data entry field on the one or more web pages as a confidential field; and
interpreting the data entry to determine a piece of confidential information.

6. The method of claim 1, wherein the generating the record comprises one or more of:
creating a graphical flowchart that depicts at least some of the sequence of inputs; and
creating a step-by-step instruction set regarding at least some of the sequence of inputs.

7. The method of claim 1, wherein the generating the record comprises:
including a selectable Uniform Resource Locator (URL) for each web page of the web pages between the first web page and the final web page to produce a plurality of URLs, wherein the other computing device selects one of the plurality of URL's to access a particular web page of the first web page to the final web page.

8. The method of claim 1 further comprises:
protecting, by the computing device, the confidential information by one of:
masking the confidential information in the record;
extracting the confidential information from the record; and
not including the confidential information when generating the record.

9. The method of claim 1 further comprises:
receiving, by the other computing device, the record;
receiving, by the other computing device, a plurality of records from a plurality of computing devices, wherein the plurality of computing devices includes the computing device; and
interpreting, by the other computing device, the plurality of records and the record to determine one or more of: access rate of various web pages, non-confidential information trends, non-confidential information patterns, and user preferences.

10. The method of claim 1 further comprises:
receiving, by the other computing device, the record; and
utilizing, by the other computing device, the record to at least one of:
mimic one or more inputs of the sequence of inputs;
access a particular web page of the first web page to the final web page; and
perform similar data entry to obtain a similar result as obtained by the computing device.

11. A computing device comprises:
a computing core that includes a processing module, main memory, an input/output interface, and a network interface;
an input device operably coupled to the computing core, wherein the input device receives a sequence of inputs regarding navigation from a first web page to a final web page and data entry into one or more web pages of the first web page to the final page; and
a display operably coupled to the computing core, wherein the display displays graphical representations regarding the navigation from the first web page to the final web page and the data entry, wherein, when activated, the processing module is operable to:
capture one or more of: the sequence of inputs, web addresses for web pages from the first web page to the final web page, user information associated with the computing device, graphical data of the web pages from the first web page to the final web page, and graphical data regarding the data entry to produce captured web page data;
identify confidential information associated with the captured web page data;
generate record based on the captured web page data, wherein the record is generated in a manner that protects the confidential information from unauthorized access;
send, via the network interface, the record to another computing device.

12. The computing device of claim 11, wherein the processing module is further operable to:
activate the capturing, the identifying, the generating, and the sending automatically upon detection of accessing the first web page.

13. The computing device of claim 11, wherein the processing module is further operable to:
receive, via the input device or via the network interface, a command to activate the capturing, the identifying, the generating, and the sending.

14. The computing device of claim 11, wherein the processing module is further operable to capture by one or more of:
generating screenshots in correspondence with the sequence of inputs;
accessing system memory of the computing device to obtain the user information;
recording Uniform Resource Locator (URL) of the web pages from the first web page to the final web page;
recording key strokes associated with the sequence of inputs; and
recording the data entry.

15. The computing device of claim 11, wherein the processing module is further operable to identify the confidential information by one or more of:
identifying a data entry field on the one or more web pages as a confidential field; and
interpreting the data entry to determine a piece of confidential information.

16. The computing device of claim 11, wherein the processing module is further operable to generate the record by one or more of:
creating a graphical flowchart that depicts at least some of the sequence of inputs; and
creating a step-by-step instruction set regarding at least some of the sequence of inputs.

17. The computing device of claim 11, wherein the processing module is further operable to generate the record by:
including a selectable Uniform Resource Locator (URL) for each web page of the web pages between the first web page and the final web page to produce a plurality of URLs, wherein the other computing device selects one of the plurality of URL's to access a particular web page of the first web page to the final web page.

18. The computing device of claim 11, wherein the processing module is further operable to:
protect the confidential information by one of:
masking the confidential information in the record;
extracting the confidential information from the record; and
not including the confidential information when generating the record.

19. A computer program product for displaying graphical representations regarding website navigation, the computer program product comprising:
one or more computer readable storage devices and program instructions stored on the one or more computer readable storage devices, the stored program instructions comprising:
program instructions to:
receive a sequence of inputs regarding navigation from a first web page to a final web page and data entry into one or more web pages of the first web page to the final page;
display graphical representations regarding navigation from the first web page to the final web page and the data entry by:
capturing one or more of: the sequence of inputs, web addresses for web pages from the first web page to the final web page, user information associated with the computing device, graphical data of the web pages from the first web page to the final web page, and graphical data regarding the data entry to produce captured web page data;
identifying confidential information associated with the captured web page data;
generating record based on the captured web page data, wherein the record is generated in a manner that protects the confidential information from unauthorized access;
sending the record to another computing device.

20. The computer program product of claim 19, wherein the program instructions further comprise one or more of:
the capturing including one or more of:
generating screenshots in correspondence with the sequence of inputs;
accessing system memory of the computing device to obtain the user information;
recording Uniform Resource Locator (URL) of the web pages from the first web page to the final web page;
recording key strokes associated with the sequence of inputs; and
recording the data entry;
the identifying the confidential information including one or more of:
identifying a data entry field on the one or more web pages as a confidential field; and
interpreting the data entry to determine a piece of confidential information; and
the generating the record including one or more of:
creating a graphical flowchart that depicts at least some of the sequence of inputs; and
creating a step-by-step instruction set regarding at least some of the sequence of inputs.
